(19) United States
(12) Patent Application Publication
(10) Pub. No.: US 2010/0196647 A1
(43) Pub. Date: Aug. 5, 2010

(54) SHINGLE SEALANT AND ADHESIVE

(75) Inventors: Michael L. Bryson, Independence, MO (US); Matti Kiik, Richardson, TX (US)

Correspondence Address: BAKER & MCKENZIE LLP;PATENT DEPARTMENT, 2001 ROSS AVENUE, SUITE 2300, DALLAS, TX, 75201, US

(73) Assignee: BUILDING MATERIALS INVESTMENT CORPORATION, Wilmington, DE (US)

(21) Appl. No.: 12/363,481

(22) Filed: Jan. 30, 2009

(51) Int. Cl. B32B 33/00; E04C 2/20; E04C 2/22; E04D 1/34; B32B 37/02

(52) U.S. Cl. 428/40.3; 52/309.3; 52/309.16; 52/543; 156/278

(57) ABSTRACT

Disclosed roofing shingles and related methods of manufacturing provide a reinforced material that strengthens the bond between shingles by reducing the affect of heat on the sealant/adhesive between shingles in one or more areas where sealant/adhesive is applied or where it contacts other shingles once installed on a roof deck. The reinforcement material acts as fiber reinforcement to the sealant/adhesive. The reinforcement material intertwines with the sealant/adhesive, and thereby helps the shingles resist delaminating or slipping or blow-off when subjected to high heat conditions or on very steep sloped roofs. The reinforcement material helps retain the strength of the adhesive bond between shingles in these conditions by providing fiber reinforcement to the adhesive bond. Thus, as the adhesive turns from a solid state to a more liquefied state in hot temperatures, the totality of the reinforcement material does not so transform, and thus retains more strength in the adhesive bond between the two shingles than mere adhesive/sealant alone.

### TECHNICAL FIELD

Disclosed embodiments herein relate generally to roofing shingles and related materials, and more particularly to an improved sealant and adhesive for use with roofing shingles and related method of manufacturing the same.

### BACKGROUND

In the manufacture of shingles, it has been known that when shingles are subjected to strong winds, the winds can engage the lower edges or tab portions of the shingles, and bend them upwardly. On occasion, under strong winds, the shingles' tabs can bend upwardly in amounts sufficient that the inherent internal resistance to substantial bending and perhaps cracking can be overcome. In these cases, the mat or other structure that is formed internally of the shingle, and the asphalt material on the surfaces of the shingle, may not be sufficient to withstand such high-wind conditions.

Various approaches have been made to resist such shingle failure via cracking and the like. For example, some approaches have resorted to thickening the mat and/or asphalt material, to offer internal resistance to bending, but nonetheless, failures due to wind-related bending of tabs of shingles continue to exist. Moreover, thickening of the materials used to construct the shingles typically results in an increase in manufacturing costs due to the additional materials consumed during manufacture of the shingles. Still further, such thicker shingles often weigh substantially more than conventional shingles, leading to increased shipping costs due to the extra weight.

With the advent of plastics, much research has gone into adapting its use to the roofing industry. One popular use of such synthetics, specifically foam formed from a foamable polyurethane resin reaction mixture, is to apply it while in a liquid state by hose and spraying equipment directly onto a roof bed. This technique has proven itself to be very valuable for commercial building projects for adhering shingles, but because of its cost, the fact that it is not very pleasing aesthetically, and the fact that it is only practical on relatively flat roofs, it is not generally used as a residential roofing medium.

A more recent approach has focused on reinforcing the area of the shingles where the tabs in the buttlap portion of the shingle connect to the upper portion of the shingle proximate the headlap area. That approach is directed toward providing a wind-resistant shingle having a separate exterior reinforcement strip provided outside the rear surface of the shingle. Such a layer comprises a material that is not coated or covered by any thick layer of asphalt or the like. As a result, the materials that comprise the reinforcement strip assist in absorbing the torque that is applied to the shingle tabs by upwardly-lifting winds. Unfortunately, this approach provides nothing in the way of bonding or adhering one shingle to a subjacent shingle, in order to better seal the roof.

Perhaps the most common approach current employed is the use of strips of adhesive material along lower ends of tabs of shingles have been applied. These strips, when subjected to hot weather conditions, soften an amount sufficient that such adhesive will adhere to the next-subjacent shingle on a roof, eventually harden and adhere thereto. The thinking, of course, is that once one shingle is adhered to another, they will resist upward deflection of shingle tabs under severe wind conditions. However, such adhesive strips sometimes dries out, offering reduced adhesion. In other cases, the wind conditions can exist during high temperature conditions when such adhesive located under tabs remains soft, and thus the adhesive does not fully function in its intended manner. Accordingly, this conventional approach to the use of adhesive strips to bond shingles is adversely affect by heat, which generally inhibits their function during hot temperatures, and even more so in southern locations where hurricane and other high-wind storms often occur during hotter months.

Accordingly, what is needed is a wind-resistant shingle having an improved sealant and adhesive for use in bonding shingles together, and related methods of manufacturing and installing the same, that does not suffer from the deficiencies of the prior art.

### SUMMARY

Disclosed herein are roofing shingles and related methods of manufacturing the same having a reinforced material that strengthens the bond between shingles by reducing the affect of heat on the sealant/adhesive between multiple shingles by using the reinforcement material in one or more areas of the shingle where sealant or adhesive is applied or where it contacts other shingles once installed on a roof deck. More specifically, the reinforcement material acts as fiber reinforcement to the sealant or adhesive. The reinforcement material intertwines with the sealant or adhesive, and thereby helps the shingles resist delaminating or slipping or blow-off when subjected to high heat conditions or on very steep sloped roofs. The reinforcement material helps retain the strength of the sealant and adhesive bonds between two shingles in these conditions by providing fiber reinforcement to the adhesive bond between the two. Thus, as the adhesive turns from a solid state to a more liquefied state in hot temperatures, the reinforcement material does not so transform, and thus retains more strength in the adhesive bond between the two shingles than mere adhesive/sealant alone.

In one embodiment, a roofing shingle constructed in accordance with the disclosed principles may comprise at least one laminate layer comprising a headlap area and a buttlap area, the at least one laminate layer having an interior surface and an exterior surface. Also, the shingle may include a bituminous coating dispersed around the at least one laminate layer, where the bituminous coating on the exterior surface of the buttlap area of the at least one laminate layer provides at least a portion of an exterior surface of the shingle. This embodiment of the shingle further includes a fibrous reinforcement material located at least partially within the bituminous coating at a location on the shingle configured to adjoin a portion of second shingle. In addition, the shingle includes an adhesive provided on at least a surface of the fibrous reinforcement material opposite the at least one laminate layer, where the reinforcement material provides fiber reinforcement to the adhesive.

In another embodiment, a shingle constructed in accordance with the disclosed principles may comprise a bituminous first layer comprising a headlap area, a buttlap area and a common bond area between the headlap and buttlap areas, the first layer having an interior surface and an exterior surface. The exterior surface of only the buttlap area of the first layer provides an initial portion of an exposure surface of the shingle, while the exterior surface of the headlap and common bond areas of the first layer are configured to be overlapped by a portion of second shingle. In addition, this embodiment of the shingle comprises a bituminous second layer comprising a buttlap area and a common bond area, the second layer having an interior surface and an exterior surface. Portions of the exterior surface of the second layer are adhesively coupled to the interior surface of the buttlap area and common bond area of the first layer. In addition, the buttlap portions and common bond areas of the first and second layers are aligned and coextensive, and portions of the exterior surface of only the buttlap area of the second layer are exposed through the buttlap area of the first layer to provide another portion of the exposure surface of the shingle. Still further, this embodiment includes a fibrous reinforcement material located at least partially within the bituminous coating at a location on the first or second layer configured to adjoin a portion of second shingle. Moreover, this embodiment of the shingle comprise an adhesive provided on at least a surface of the fibrous reinforcement material, where the reinforcement material provides fiber reinforcement to the adhesive.

In another aspect, a method of manufacturing a composition roofing shingle is disclosed. In one embodiment, the method comprises forming at least one laminate layer comprising a headlap area and a buttlap area, the at least one laminate layer having an interior surface and an exterior surface. In addition, the method comprises dispersing a bituminous coating around the at least one laminate layer. In such embodiments, the bituminous coating on the exterior surface of the buttlap area of the at least one laminate layer provides at least a portion of an exterior surface of the shingle. The method may also comprise locating a fibrous reinforcement material at least partially within the bituminous coating at a location on the shingle configured to adjoin a portion of second shingle. Furthermore, the method includes providing an adhesive on at least a surface of the fibrous reinforcement material opposite the at least one laminate layer, where the reinforcement material provides fiber reinforcement to the adhesive.

### BRIEF DESCRIPTIONS OF THE DRAWINGS

For a more complete understanding of this disclosure, and the advantages of the systems and methods herein, reference is now made to the following descriptions taken in conjunction with the accompanying drawings, in which:

FIG. 1 illustrates a side view of one embodiment of an improved reinforced shingle constructed in accordance with the disclosed principles;

FIG. 2 illustrates a side view of another embodiment of an improved shingle having a reinforcement material constructed in accordance with the disclosed principles; and

FIG. 3 illustrates a side view of an exemplary roof installation using improved shingles as illustrated in FIG. 1 and constructed according to the disclosed principles.

### DETAILED DESCRIPTION

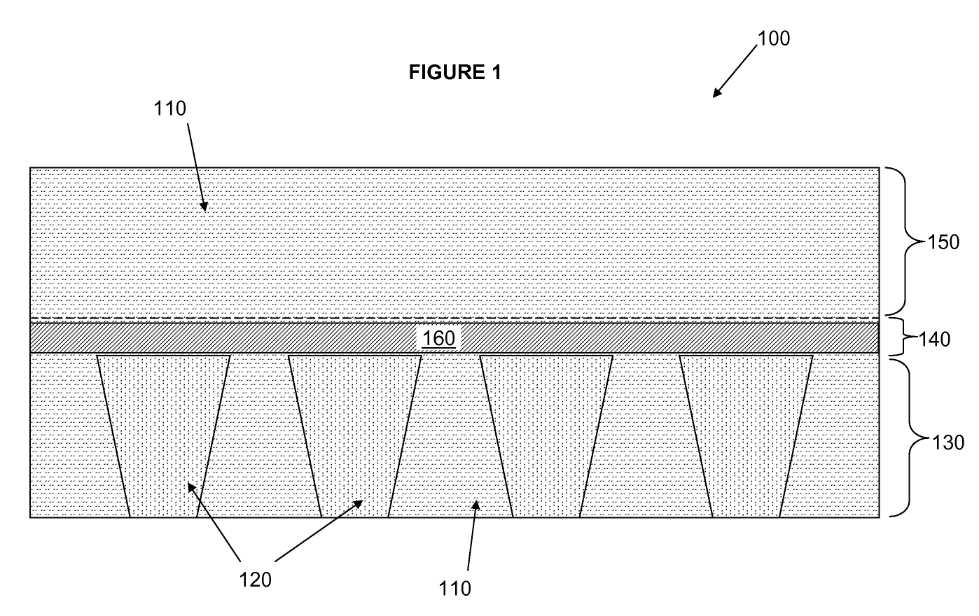

FIG. 1 illustrates a side view of one embodiment of an improved reinforced shingle 100 constructed in accordance with the disclosed principles. The illustrated exemplary shingle 100 includes a first shingle layer 110 and a second shingle layer 120 in this embodiment, the first shingle layer 110 provides the overall length and width of the shingle 100, while the second shingle layer 120 is constructed at the same overall width as the first shingle layer 110, but not its entire length. The back edge of the second shingle layer is shown in broken line through the first shingle layer 110. Also, the surface hatching on the first and second shingle layers 110, 120 are provided to distinguish the two layers from one another, and is not intended to show these two layers 110, 120 are manufactured from different materials.

The shingle 100 includes the buttlap area 130 and headlap area 150, as well as a common bond area 140 of the shingle 100 between these two areas. As a result, the first shingle layer 110 includes the buttlap area 130, the common bond area 140, and the headlap area 150 of the shingle 100, whereas the second shingle layer 120 includes only the buttlap area 130 and the common bond area 140. The exterior surface of the first shingle layer 110 provides a large portion of the exterior surface of the shingle 100, and typically includes predetermined decorative shapes cut into the buttlap area 130. Exterior portions of the second shingle layer 120 may thus be exposed through the decorative removed portions of the first shingle layer 110 to provide the remainder of the exterior surface of the shingle 100. In the illustrated embodiment, the decorative portions are illustrated in a “dragonstooth” pattern, but any pattern may be provided. The first and second shingle layers 110, 120 are typically connected together using an adhesive, for example, a bituminous based adhesive; however, fasteners may also be employed, for example, through the common bond area 140 of the shingle 100. In addition, the interior surfaces of the first and second layers 110, 120 (or third layer, etc., if present) may also include a back surfacing material, as is known in the art.

In addition, the exemplary shingle 100 also includes a reinforcement material 160 located in a reinforcement zone proximate to the common bond area 140 and on or within the exterior surface of the first shingle layer 110. In accordance with the disclosed principles, the reinforcement material 160 may be adhered to the reinforcement zone near the common bond area 140 during the manufacturing process of the shingle 100. Furthermore, the reinforcement material 160 also includes the adhesive (applied in any number of structures) typically found on conventional asphalt shingles. As discussed above, such adhesive is often provided on the conventional shingles (although typically on the underside of the buttlap area) for the buttlap area of an upper shingle to adhere and seal to the topside of the common bond area of a lower shingle. While the principle of adhering the buttlap of one shingle to the common bond area of a second shingle remains the same, the reinforcement material 160 substantially improves this adhesion by strengthening the bond between the two shingles.

The disclosed principles strengthen the bond between shingles by reducing the affect of heat on the sealant/adhesive between multiple shingles by using the reinforcement material 160 in one or more areas of the shingle 100 where sealant or adhesive is applied or where it contacts other shingles once installed on a roof deck. More specifically, the reinforcement material 160 acts as fiber reinforcement to the sealant or adhesive. The reinforcement material 160 intertwines with the sealant or adhesive, and thereby helps the shingles resist delaminating or slipping or blow-off when subjected to high heat conditions or on very steep sloped roofs. Laminated shingles or heavy strip shingles are prone to delaminating or slipping on very steep slope applications, especially in very hot direct sunlight situations, since the adhesive/sealant typically used tends to liquefy in such hot conditions. This results in weakening the adhesive bond between shingles, and thus in delaminating or sliding of the shingles with respect to one another as the adhesive becomes more liquefied. The reinforcement material 160 helps retain the strength of the sealant and adhesive bonds between two shingles in these conditions by providing fiber reinforcement to the adhesive bond between the two. Thus, as the adhesive turns from a solid state to a more liquefied state in hot temperatures, the reinforcement material 160 does not so transform, and thus retains more strength in the adhesive bond between the two shingles than mere adhesive/sealant alone.

Furthermore, the common bond area 140 is typically where installers are instructed to drive roofing nails through the shingles 100 since this area not only includes both the first and second shingle layers 110, 120, but also is intended to be covered (i.e., sealed) by the buttlap area 130 of another shingle 200. However, shingles that are not fastened in this manner, for example, with the nails or other fasteners applied above and out of the manufacturers recommended nail zones (i.e., the common bond area 140), are especially prone to delamination, shingle slippage, or blow-offs under high heat conditions. Accordingly, by providing the reinforcement material 160 in a reinforcement zone where the front edge of a second shingle, which includes the tab area that is prone to lifting in high winds, the adhesion of one shingle to another is reinforced or strengthened, thereby reducing blow-ff, as well as shingle slippage even in situations where the roofing fasteners are not properly driven through the shingle nail zone.

In a specific embodiment, the reinforcement material 160 may be applied to the shingle 100 during the manufacturing process. For example, the reinforcement material 160 can be applied to the hot asphalt-based coating that comprises the exterior surface of the first shingle layer 110. By locating the reinforcement material 160 during this or another similar stage of the manufacturing process, this allows part of the reinforcement material 160 to melt or blend into the asphalt or other bituminous material/coating on the exterior shingle surface, or to be encapsulated by the asphalt material. The reinforcement material 160 may even replace a portion of the bituminous coating typically applied to the exterior surface of the shingle 100. In either embodiment, the reinforcement material 160 is firmly held in place at the top surface of the first shingle layer 110 once the shingle 100 cools. Alternatively, the reinforcement material 160 may be formed into and/or as part of the first shingle layer 110.

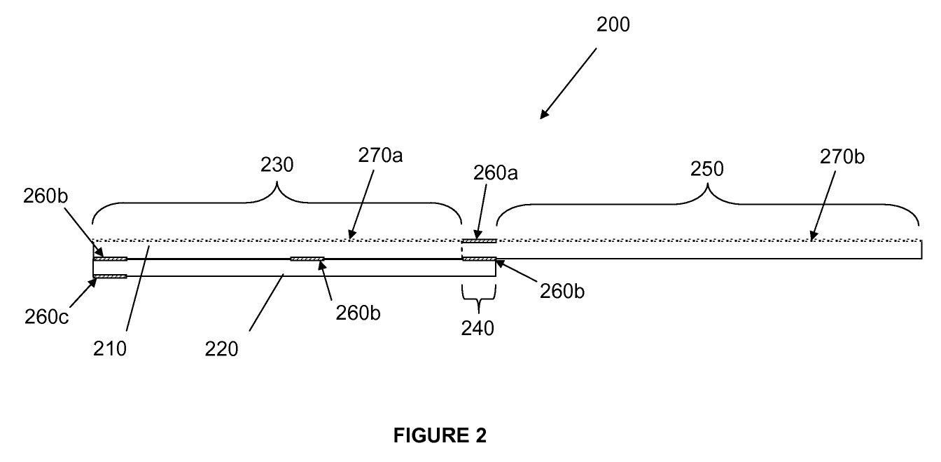

Moreover, in some embodiments, the reinforcement material 160 may take the place of mineral surface materials typically added to the exterior surface of a composite roofing shingle. The granules or other mineral surface materials do not typically provide a good adhesion surface for adhesives provided on the underside of the buttlap area 130 of a neighboring shingle. This is because the granules do not provide a substantially flat adhesion surface, and can also come loose from the single's exterior surface over time or due to hot conditions. In this embodiment, however, some or all of the granules/mineral materials in the reinforcement zone are replaced by the reinforcement material 160, which provides a much better surface for adhesion from a shingle laid on top of this shingle 100. FIG. 2 below illustrates such an embodiment.

The material used for the reinforcement material 160 could beneficially be a fabric. The fabric used could be a woven, nonwoven, or spunbond material, and may be constructed using a wet-laid or dry-laid process. In addition, the fiber material may be made using synthetic fibers, such as polyester fibers, but may also be made or blended with fiberglass, polyolefin, nylon, cellulose, or any other suitable fibrous material. Moreover, synthetic fiber material may also contain minor portions of natural fibers, such as wood pulp. Also, fibers selected may be chopped fibers or they may be continuous fiber strands, such as those used spunbond process.

The weight of a fabric material for the reinforcement material 160 depends on the properties of the material used. A material that melts or fuses with the asphalt or bituminous material may need to be thicker or heavier than one that does not. A polyester-based fabric may need to weigh at least 1.25 lb/100 sq. ft., whereas a fiberglass fabric may give comparable results at 0.75 lb/100 sq. ft.

FIG. 2 illustrates a side view of another embodiment of an improved shingle 200 having a reinforcement material constructed in accordance with the disclosed principles. The illustrated exemplary shingle 200 again includes a first shingle layer 210 and a second shingle layer 220. In addition, the shingle 200 also includes a buttlap area 230 and a headlap area 250, similar to those discussed above, as well as a common bond area 240 between these two areas. The first and second shingle layers 210, 220 may again be connected together using an adhesive, for example, a bituminous based adhesive; however, fasteners may also be employed.

In addition, this embodiment of the shingle 200 also includes a reinforcement material 260a located proximate to the common bond area 240 and on the exterior surface of the first shingle layer 210. In accordance with the disclosed principles, the reinforcement material 260a may be adhered to, or formed into, the top (i.e., exterior) surface of the first shingle layer 210, and preferably extends the entire width of the shingle 200. The placing or forming of the reinforcement material 260a in this particular location in the exterior surface of the first shingle layer 210 may be as described above with reference to FIG. 1. This may comprise locating the reinforcement material 260a into the upper surface of a bituminous coating placed on the exterior surface of the first layer 210. Additionally, the shingle 200 may include granules 270a, 270b disposed in the exterior surface of the first layer 210 or that bituminous coating. In such an embodiment, the upper exterior surface of the reinforcement material 260a may be made flush with the granules 270a, 270b, and thus may be made free of the granules 270a, 270b. Also, although granules 270a, 270b are illustrated extending across most of the exterior surface of the first layer 210, on granules 270a on the exposure surface of the shingle 200 may be included, if desired.

In addition, this embodiment of the shingle 200 also includes reinforcement material as disclosed herein in other locations. Specifically, as illustrated, reinforcement material 260b may be located between the first and second shingle layers 210, 220. Since the disclosed construction of the reinforcement material/zone provides improved adhesion, along with reinforced strength, between whole shingles, the disclosed principles can advantageously be employed in other locations where good, strong shingle adhesion is desired. Accordingly, the reinforcement material 260b can be located on the interior surface (e.g., underside) of the first shingle layer 210, on the exterior surface of the second shingle layer 220, or both. Moreover, the reinforcement material 260b may be strategically located where adhesion between the first and second shingle layers 210, 220 is often most critical. As shown, these locations can include the front and back edges of the second shingle layer 220, as well as between the tab portions of the first shingle layer 210 and corresponding locations on the second shingle layer 220.

Still further, as also illustrated in FIG. 2, reinforcement material 260c may also be located on the interior surface (e.g., underside) of the second shingle layer 220. More specifically, this reinforcement material 260c may be located at the front edge of the second shingle layer 220 to provide the strengthened adhesion provided by the disclosed principles to the front edge (i.e., the lower edge of the shingle 200 when mounted on a roof deck). In similar embodiments, reinforcement material 260a on the top of the first shingle layer 210 in the common bond area 240 may be provided along with the reinforcement material 260c at the bottom, front edge of the second shingle layer 220. In such embodiments, the adhesion between first and second shingles 200 could be even further strengthened.

Although a dual or bi-layered shingle 200 is illustrated in FIG. 2, it should be noted that the disclosed principles can easily incorporate the disclosed reinforcement material in other types of shingles. For example, in shingles having three or more layers, the reinforcement material may be placed between each of the three or more layers in locations similar to those illustrated in the two-layer shingle 200 in FIG. 2. Additionally, the disclosed principles may be employed in single layered shingles, for example, in the reinforcement area proximate the common area described above, or on the underside of the buttlap portion at the front edge of the shingle, or both. Thus, in such embodiments, the reinforcement material would be located similar to the reinforcement material 160a and 160c illustrated in FIG. 2.

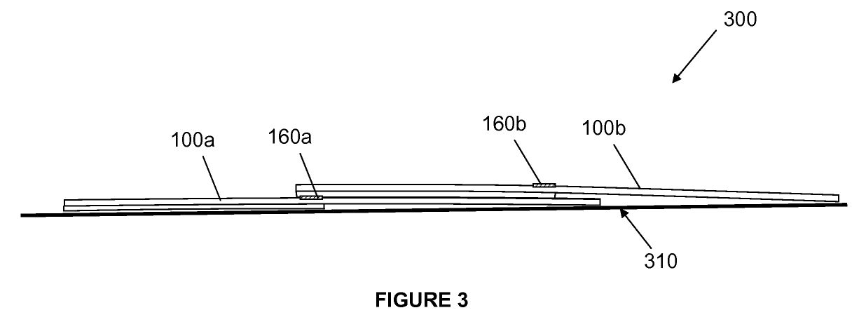

FIG. 3 illustrates a side view of an exemplary roof installation 300 using improved shingles as illustrated in FIG. 1, and constructed according to the disclosed principles. The exemplary shingles 100a, 100b each again include a first shingle layer 110 and a second shingle layer 120, as discussed with regard to FIG. 1. The shingles 100a, 100b may also include the decorative shapes cut into the buttlap area of each shingle 100a, 100b, such as a typical “dragonstooth” pattern, but any pattern may be provided. In the exemplary configuration, two shingles 100a, 100b are illustrated overlapping one another on a roof deck 310. In addition, as the shingles 100a, 100b are overlapped, the headlap area of the lower shingle 100a is covered by the buttlap area of the upper shingle 100b.

The exemplary shingles 100a, 100b also each include a reinforcement material 160a, 160b located in a respective reinforcement zone proximate to the common bond area of each shingle 100a, 100b. Moreover, in the illustrated installation, the reinforcement material 160a, 160b is provided on or within the exterior surface of the first shingle layer of each shingle 100a, 100b. Furthermore, as before, the reinforcement material 160a, 160b also includes the adhesive typically found on conventional asphalt shingles.

As discussed above, such adhesive is provided to adhere and seal the buttlap area of an upper shingle 100b to the topside of the common bond area of a lower shingle 100a. Specifically, the reinforcement material 160a, 160b substantially improves this adhesion between the two singles 100a, 100b by strengthening the adhesive bond between the two. The bond between shingles 100a, 100b is strengthened by reducing the affect of heat on the sealant/adhesive between the shingles 100a, 100b by using the reinforcement material 160a, 160b in one or more areas where sealant or adhesive is applied.

In this illustrated embodiment, the reinforcement material 160a, 160b is provided on or partially within the exterior surface proximate the common bond area of the bottom shingle 100a such that the front edge of the buttlap area of the top shingle 100b is securely adhered to the bottom shingle 100b at this point. The reinforcement material 160a, 160b is provided on the exterior surface of the shingles 100a, 100b, for example, by blending the material 160a, 160b with the outer bituminous coatings applied to asphalt-based shingles during the latter stages of manufacture. Alternatively, the reinforcement material 160a, 160b may be provided partially within the shingles 100a, 100b by replacing at least a portion of the first shingle layer of the shingles 100a, 100b with the material 160a, 160b, and then continuing with the remainder of the manufacturing process as before. Still further, a portion in the reinforcement area of one of the laminate layers used to form the first layer may be constructed from the reinforcement material 160a, 160b, and perhaps even raised compared to the remainder of the laminate layer, in order to provide the reinforcement material 160a, 160b at the desired area.

It should be noted that although the shingles 100a, 100b illustrated in FIG. 3 are not shown fully seated against and sealed to one another, and against the roof deck 310, the finished shingles 100a, 100b are typically manufactured from a flexible material, such as asphalt, and thus will curve down after installation to seat against an adjacent shingle. Also, although only two shingles 100a, 100b are illustrated, a complete roofing installation will of course include many more shingles similarly constructed and laid with adjoining shingles. Furthermore, although bi-layered shingles 100a, 100b are illustrated based on the shingle embodiment shown in FIG. 1, the disclosed principles can also be employed with shingles having three or more layers, or even with single layer shingles.

While various embodiments of the apparatuses, systems and methods constructed according to the principles disclosed herein are disclosed herein and have been described above, it should be understood that they have been presented by way of example only, and not limitation. The breadth and scope of the invention(s) should thus not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in the claims found herein. Multiple inventions are set forth according to the limitations of the multiple claims associated with this disclosure, and the claims accordingly define the invention(s), and their equivalents, that are protected thereby. In all instances, the scope of the claims should not be constrained by the headings set forth herein.

What is claimed is:

1. A composition roofing shingle, comprising:
at least one laminate layer comprising a headlap area and a buttlap area, the at least one laminate layer having an interior surface and an exterior surface;
a bituminous coating dispersed around the at least one laminate layer, the bituminous coating on the exterior surface of the buttlap area of the at least one laminate layer providing at least a portion of an exterior surface of the shingle;
a fibrous reinforcement material located at least partially within the bituminous coating at a location on the shingle configured to adjoin a portion of a second shingle; and
an adhesive provided on at least a surface of the fibrous reinforcement material opposite the at least one laminate layer, the reinforcement material providing fiber reinforcement to the adhesive.

2. A composition roofing shingle according to claim 1, wherein the reinforcement material extends the entire width of the shingle.

3. A composition roofing shingle according to claim 1, wherein the reinforcement material is located proximately between the headlap and buttlap areas of the at least one laminate layer.

4. A composition roofing shingle according to claim 1, wherein the reinforcement material is located on the underside of the buttlap area, proximate to the front edge of shingle.

5. A composition roofing shingle according to claim 1, further comprising granules disposed in the exterior surface of the first layer.

6. A composition roofing shingle according to claim 5, wherein the reinforcement material is located within the bituminous coating, an exterior surface of the reinforcement material being even with an exterior surface of the bituminous coating and being free of the granules.

7. A composition roofing shingle according to claim 1, wherein the reinforcement material is at least partially melted into the adhesive.

8. A composition roofing shingle according to claim 1, wherein the reinforcement material comprises at least one of woven, nonwoven, or spunbond material.

9. A composition roofing shingle according to claim 1, wherein the reinforcement material comprises at least one of polyester, fiberglass, polyolefin, nylon, wood, or cellulose fibers.

10. A composition roofing shingle according to claim 1, wherein the reinforcement material comprises chopped fibers or continuous fiber strands.

11. A composition roofing shingle, comprising:
a bituminous first layer comprising a headlap area, a buttlap area and a common bond area between the headlap and buttlap areas, the first layer having an interior surface and an exterior surface, wherein the exterior surface of only the buttlap area of the first layer provides an initial portion of an exposure surface of the shingle while the exterior surface of the headlap and common bond areas of the first layer are configured to be overlapped by a portion of second shingle;
a bituminous second layer comprising a buttlap area and a common bond area, the second layer having an interior surface and an exterior surface, wherein portions of the exterior surface of the second layer are adhesively coupled to the interior surface of the buttlap area and common bond area of the first layer;
wherein the buttlap portions and common bond areas of the first and second layers are aligned and coextensive, and wherein portions of the exterior surface of only the buttlap area of the second layer are exposed through the buttlap area of the first layer to provide another portion of the exposure surface of the shingle;
a fibrous reinforcement material located at least partially within the bituminous first or second layer at a location on the first or second layer configured to adjoin a portion of a second shingle; and
an adhesive provided on at least a surface of the fibrous reinforcement material, the reinforcement material providing fiber reinforcement to the adhesive.

12. A composition roofing shingle according to claim 11, wherein the reinforcement material extends the entire width of the shingle.

13. A composition roofing shingle according to claim 11, wherein the reinforcement material is located on the exterior surface of the first bituminous layer proximate to the common bond area.

14. A composition roofing shingle according to claim 11, wherein the reinforcement material is located on the interior surface of the first bituminous layer proximate to the common bond area.

15. A composition roofing shingle according to claim 11, wherein the reinforcement material is located on the interior surface of the second bituminous layer, proximate to the front edge of shingle.

16. A composition roofing shingle according to claim 11, wherein the reinforcement material is located between the first and second bituminous layers proximate to the portions of the exterior surface of the buttlap area of the second layer that are exposed through the buttlap area of the first layer to provide another portion of the exposure surface of the shingle.

17. A composition roofing shingle according to claim 11, further comprising granules disposed in the exterior surface of the first bituminous layer.

18. A composition roofing shingle according to claim 17, wherein the reinforcement material is located within the exterior surface of the first bituminous layer, an exterior surface of the reinforcement material being even with the exterior surface of the first layer and being free of the granules.

19. A composition roofing shingle according to claim 11, wherein the reinforcement material is at least partially melted into the adhesive.

20. A composition roofing shingle according to claim 11, wherein the reinforcement material comprises at least one of woven, nonwoven, or spunbond material.

21. A composition roofing shingle according to claim 11, wherein the reinforcement material comprises at least one of polyester, fiberglass, polyolefin, nylon, wood, or cellulose fibers.

22. A composition roofing shingle according to claim 11, wherein the reinforcement material comprises chopped fibers or continuous fiber strands.

23. A composition roofing shingle according to claim 11, further comprising a bituminous third layer comprising a buttlap area and a common bond area, the third layer having an interior surface and an exterior surface, wherein portions of the exterior surface of the third layer are adhesively coupled to the interior surface of the buttlap area and common bond area of the second layer, and wherein the buttlap portions and common bond areas of the second and third layers are aligned and coextensive and portions of the exterior surface of only the buttlap area of the third layer are exposed through the buttlap area of the first layer to provide a further portion of the exposure surface of the shingle.

24. A composition roofing shingle according to claim 23, wherein the reinforcement material is located on the interior surface of the second bituminous layer proximate to the common bond area.

25. A composition roofing shingle according to claim 23, wherein the reinforcement material is located proximately on the interior surface of the third bituminous layer, proximate to the front edge of shingle.

26. A composition roofing shingle according to claim 23, wherein the reinforcement material is located between the second and third bituminous layers proximate to the portions of the exterior surface of the buttlap area of the third layer that are exposed through the buttlap area of the first layer to provide a further portion of the exposure surface of the shingle.

27. A method of manufacturing a composition roofing shingle, the method comprising:
forming at least one laminate layer comprising a headlap area and a buttlap area, the at least one laminate layer having an interior surface and an exterior surface;
dispersing a bituminous coating around the at least one laminate layer, the bituminous coating on the exterior surface of the buttlap area of the at least one laminate layer providing at least a portion of an exterior surface of the shingle;
locating a fibrous reinforcement material at least partially within the bituminous coating at a location on the shingle configured to adjoin a portion of second shingle; and
providing an adhesive on at least a surface of the fibrous reinforcement material opposite the at least one laminate layer, the reinforcement material providing fiber reinforcement to the adhesive.

28. A method according to claim 27, wherein the reinforcement material extends the entire width of the shingle.

29. A method according to claim 27, wherein the reinforcement material is located proximately between the headlap and buttlap areas of the at least one laminate layer.

30. A method according to claim 27, wherein locating the reinforcement material comprises locating the reinforcement material on the underside of the buttlap area, proximate to the front edge of shingle.

31. A method according to claim 27, further comprising disposing granules in the bituminous coating on the exterior surface of the first layer.

32. A method according to claim 31, wherein locating the reinforcement material comprises locating the reinforcement material within the bituminous coating, an exterior surface of the reinforcement material being even with an exterior surface of the bituminous coating and being free of the granules.

33. A method according to claim 27, wherein locating the reinforcement material comprises at least partially melting the reinforcement material into the adhesive.

34. A method according to claim 27, wherein the reinforcement material comprises at least one of woven, nonwoven, or spunbond material.

35. A method according to claim 27, wherein the reinforcement material comprises at least one of polyester, fiberglass, polyolefin, nylon, wood, or cellulose fibers.

36. A method according to claim 27, wherein the reinforcement material comprises chopped fibers or continuous fiber strands.
